(19) United States
(12) Patent Application Publication
(10) Pub. No.: US 2010/0228829 A1
(43) Pub. Date: Sep. 9, 2010

(54) MOBILE DATABASE NETWORK

(76) Inventor: Meir Niv, West Hill, CA (US)

Correspondence Address: Meir Niv, 6617 Vickiview dr, West Hill, CA, 91307, US

(21) Appl. No.: 12/399,240

(22) Filed: Mar. 6, 2009

(51) Int. Cl. G06F 17/30; G06F 15/16

(52) U.S. Cl. 709/206; 707/E17.032

(57) ABSTRACT

A method and a system for mobile distributed processing are presented. The method includes the steps of receiving, from a server, a message contained in a database and determining a type of the message for presenting the message. If the message is of a multi media type, at least displaying images contained in the message on a display. If the message is of a data type, displaying data contained in the message on the display. If the message is of an audio type, reproducing audio associated with the message in an audible fashion. The method further including the steps of terminating receiving of the message and sending an active request to the server to set a status of the message in the database to execution done.

### CROSS-REFERENCE TO RELATED APPLICATIONS

The present Utility patent application claims priority benefit of the U.S. provisional application for patent Ser. No. 60/976,600 filed on Oct. 1, 2007 under 35 U.S.C. 119(e). The contents of this related provisional application are incorporated herein by reference for all purposes.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to digital messages. More particularly, the invention relates to a database network to which digital messages from mobile devices may be stored and shared.

### BACKGROUND OF THE INVENTION

Most conventional control scheme rely on a message queue. There is a server that manages the queue. Message queues, for example, are provided by companies like Microsoft and IBM. Such message queues are a proprietary protocol and require special programming skill and are generally limited to the vendor. Message queues stream data between computers. Thus, there is a need for communication between the computers without a proprietary server to handle the messages; especially, for mobile devices.

As an example of messages that include multimedia information, many currently available handheld devices include cameras that enable a user to take digital photo messages. In many cases after the user takes these photo messages, he would like to process the message, for example, without limitation, store the photo in a location other than the handheld device, share the photo with other users, or add data to the photo such as, but not limited to, voice recordings or time and location information.

Presently, the typical method for processing photos involves sending an email of the photos to other computers or transferring photos to removable storage devices such as, but not limited to, storage disks, memory cards or flash drives. Using this method, a user then must process the data and store it in a database. This method is labor intensive, time consuming and may not be accurate. Also, with potentially hundreds of active users, a system such as this will most likely become overwhelmed and ineffective. For example, without limitation, if a user snaps a few dozen pictures at a time and the system includes a few hundred members, the manual processing becomes overwhelming.

Furthermore, users of mobile devices sometimes wish to connect as a network with a controller and message queue. Currently known methods available to create a repository for holding data and a central controller for sending messages to other computers include the following. One approach is a centralized database server in which other computer units are clients that communicate with the one main database through transmission control protocol or internet protocol (TCP/IP). The disadvantage of this approach is most acute in cases of mobile units where the communication is not always contiguous and switches on and off and where the mobile units may not have access to the database. On the other hand, using a replication database, there is always a local database to which mobile users have access. Also, filtering does not exist in a centralized database server, and the main database is not as robust and dynamic as it could be if designed with a replication database. Another currently known method is the use of a message queue protocol. This is a proprietary protocol developed, for example, without limitation, by the like of Microsoft or IBA, which is difficult to understand and install, depends on a central server, and is not flexible. XML script may also be used and is supposed to be universal; however, XML script is not replicated and changes are difficult to distribute throughout the network. Object oriented languages such as, but not limited to, Java, Small talk, .Net may also be used. However, these languages do not have remote object capabilities. These languages are limited to a particular language and are difficult for most people to understand.

E-mail is one of the most important software tools for users of computing devices. Computer users often find e-mail essential for many of their activities. E-mail is used everywhere and at almost any location. Currently e-mail is limited to deliver messages or file attachments and there is limited management control. There are also problems with security and control of access with currently known email systems.

In view of the foregoing, there is a need for an improved method for processing digital messages from handheld devices that is quick, easy and accurate and an improved method of creating a data and message processing system using a replication database.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary enterprise network for processing digital photos, in accordance with an embodiment of the present invention; and

FIG. 2 is a flowchart illustrating exemplary steps in receiving a message in a mobile distributed processing system (MDPS), according to an embodiment of the present invention.

Unless otherwise indicated illustrations in the figures are not necessarily drawn to scale.

### SUMMARY OF THE INVENTION

To achieve the forgoing and other objects and in accordance with the purpose of the invention, a mobile database network is presented.

In one embodiment, a method for mobile distributed processing is presented. The method includes the steps of receiving, from a server, a message contained in a database and determining a type of the message for presenting the message. If the message is of a multi media type, at least displaying images contained in the message on a display. If the message is of a data type, displaying data contained in the message on the display. If the message is of an audio type, reproducing audio associated with the message in an audible fashion. The method further including the steps of terminating receiving of the message and sending an active request to the server to set a status of the message in the database to execution done. In other embodiments, receiving is on a mobile device and over the Internet using a gateway server for security. In another embodiment the audio is an alert indicating a further message is available. In further embodiments, the step of receiving further includes replicating at least a portion of the database containing the message to form a replicated database and the replicating includes filtering to provide security of information in the database. In other embodiments the message includes, in part, captured information from a user on the system, data associated with the captured information and the captured information includes images. In still other embodiments the step of sending an active request further includes sending information as to when the message was received and sending an additional message to be included in the database with the message wherein the sending an additional message is for the purpose of collaborating with the user. In further embodiments, the additional message includes additional captured information and the additional captured information includes images. In another embodiment, the additional message is added to the replicated database where at least a portion of the replicated database is sent to the server for replicating into the database. In yet other embodiments, the step of sending an active request further includes sending a request to process a program on a destination device and return results in a message form using the database and sending a request to control a process on a remote device. In still another embodiment the step of receiving is on an enterprise network.

In another embodiment a method for mobile distributed processing is presented. The method includes steps for receiving, from a server, a message contained in a database, steps for determining a type of the message, steps for presenting the message, steps for terminating receiving of the message and steps for sending an active request to the server.

In another embodiment a system for mobile distributed processing is presented. The system includes means for receiving, from a server, a message contained in a database, means for determining a type of the message for presenting the message, means for displaying images contained in the message on a display, means for displaying data contained in the message on the display, means for reproducing audio associated with the message in an audible fashion, means for terminating receiving of the message and means for sending an active request to the server.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

In the following description, whenever a “message” is referred to, it should be understood to mean any kind of information transmitted/received from/to a source device of the present invention. Such messages include, without limitation, a voice message, written data, multimedia date (e.g., photo, video, music, voice, etc), and control/protocol data.

The preferred embodiment of the present invention applies to mobile devices equipped with a camera and messaging applications, running an operating system such as, but not limited to, Window mobile, by Microsoft, that support a local database that also has been replicated with other devices on a network. In the preferred embodiment, the mobile device is part of an enterprise network, which includes other devices such as, but not limited to, other mobile devices, desktop computers, and servers running various applications. In the preferred embodiment, the connection to the enterprise network is made using a transmission control protocol or internet protocol (TCP/IP) communication protocol such as, but not limited to, the internet.

A problem with conventional processes that is addressed by the preferred embodiment of the present invention is the current process by which messages are distributed through mobile devices, which is inefficient and in many cases time consuming. In the preferred embodiment, the originator of a message is a user of a mobile device that is integrated in an enterprise network. In this embodiment the message is stored directly in a database and all of the users on the network have access to the message and its associated data immediately with no additional processing required.

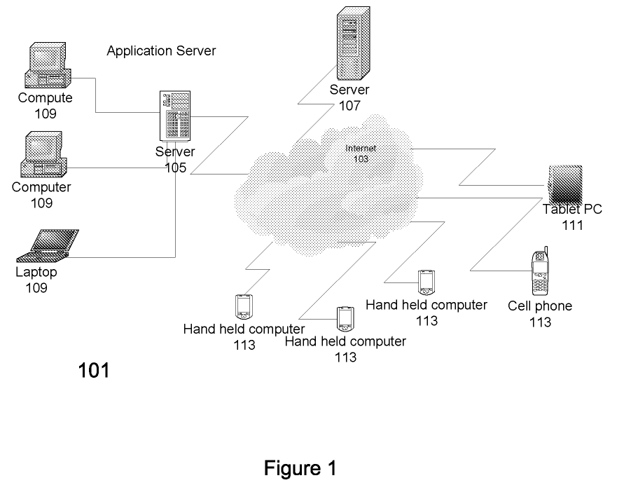

FIG. 1 illustrates an exemplary enterprise network 101 for processing digital messages, in accordance with an embodiment of the present invention. In the present embodiment, enterprise network 101 comprises a publisher server 107 and subscribers. These subscribers comprise various devices such as, but not limited to, computers, tablet PCs, handheld devices, and cell phones. Publisher server 107 is a server that centralizes distribution and holds the contents of an enterprise database. The enterprise database may be configured as a central database or a replication database. In some embodiments the enterprise database is a central database that all users may access. However, in these embodiments, there is only one copy of the enterprise database at the publisher server. In the present embodiment, the enterprise database is a replication database. In this configuration, the enterprise database is replicated on other nodes, for example, without limitation, computers, laptops, mobile devices, etc., and the nodes have the same copy of the enterprise database in their local databases. When changes are made in the enterprise database at any node, all other nodes replicate that change in their respective enterprise databases in their local databases.

Embodiments using a replication schema for publisher server 107 have some advantages over a centralized database. For example, without limitation, a replication schema provides automatic backup and data integrity. Also, all nodes are constantly active, even when the connection fails temporary. A replicated database may provide performance enhancement as different functions are performed on individual hardware and not all on one server. For example, without limitation, mobile devices may perform functions such as, but not limited to, taking photos automatically on remote command, taking video, voice recording, and sending command signals to attached controllers such as, but not limited to, a machine, gate, fire hose, alarm, etc. Desktops or laptops servers typically provide services to mobile devices such as, but not limited to, running an application, for example, without limitation, a search, by command from a mobile device, storing lengthy reports on the database for which the mobile device has access, providing access to portions of the internet for which the mobile devices are not designed, etc.

Using a replication database, transactions can be performed at the individual processor as opposed to all being performed at a central database. With a central database, every update causes a momentary lock of the database while in transaction of the record, and the same record may be updated many different times. With hundreds of transactions occurring at a time on a central database, the system can slow almost to a halt. However, synchronization using a replication database is fast and only data that has been changed is transferred at once. Also synchronization can be scheduled when the system is not busy. Another function that stresses a central database is reporting. Experience shows that when reporting is being performed, the database slows. Using a replicated database, the reporting may be performed on a separated computer, while other users are not even aware that reporting has occurred. However, the result of the reporting is available to all of the users in need of the reporting, free of paying for the process. This attribute results in less lock unlock and so on, for example, without limitation, a transaction on a replication database does not share the same physical sever as the reporting unit. A replicated database as a network of distributed information is more secure then an open internet distribution system. Also, a replicated database addresses a smaller audience. Hackers typically do not bother with databases in a closed system as often as they do with the internet. However, a replicated database schema may require special installation on each node that has a database in the system, and each node should be protected from being physically compromised or stolen.

In the present embodiment, the subscribers are nodes of enterprise network 101 that hold all or part of the enterprise database, as some nodes need only partial data. For example, without limitation, nodes that are mobile may only replicate part of the database. In the present embodiment, the nodes are synchronized with publisher server 107 so that both the publisher data and the node data are replicated. In the present embodiment, this is repeated with every node. It is most common to initiate the synchronization from the subscriber; however, there are some exceptions where synchronization is initiated by the publisher. The publisher starts synchronization, or pushes, mostly on units that are not mobile and have fixed IPs. Mobile units are pull subscribers because they have a dynamic IP and the publisher may not know where the units are located (their IP). In the present embodiment when synchronization takes place, only changes are transmitted so that the taxing of the system is minimal.

In the present embodiment, an application server 105 controls replication subscribers 109 of enterprise network 101. In the present embodiment, replication subscribers 109 are computers and a laptop; however, alternate embodiments may have various different types of devices connected to the enterprise network through servers with replication subscriptions. Not all devices must be connected to enterprise network 101 through a server. For example, without limitation, in the present embodiment a replication subscriber 111, a tablet PC, is connected directly to the internet 103 as part of enterprise network 101. In the present embodiment several mobile subscribers 113 are wirelessly connected to enterprise network 101 through the internet 103. Mobile subscribers 113 differ little from replication subscribers 109 and 111 except that in most cases mobile subscribers 113 only replicate part of the data in their local databases. Mobile subscribers 113 are typically connected through WiFi at hotspots, which provide a reasonably sufficient speed or through a cell phone provider at a lower speed. However, there is no grantee that there will be connection in some rural areas. Those skilled in the art, in light of the present teachings, will recognize that various different types of devices may be connected to enterprise network 101 through various different means.

The typical use of the present embodiment applies to messages processed by mobile devices that are stored in the local databases of the mobile devices and are replicated though out the enterprise network. The message may be supplemented with data and cataloging information such as, but not limited to, a voice recording, data about the message, a user profile, the time when processed, if the mobile device is equipped with GPS, the location information, an assigned priority of importance, and other custom data. In the present embodiment, the local database on the mobile device is synchronized with the enterprise database when the local database on the mobile device wirelessly transfers its data, for example without limitation photos, voice messages, and date and time data, to the enterprise database. This bypasses normal sending of such data such as, but not limited to, emails and uploading, by sending the data directly to the enterprise database that others on the enterprise network can access, providing all users of the enterprise network with an instant copy of the same message record. This process enables a readily available mobile device to provide a useful record and message in real-time without extra processing.

A non-limiting example of use of the preferred embodiment of the present invention is as follows. A policeman suspects an individual who has just entered a subway station as a potential terrorist. The policeman can run a custom application in a mobile device, where relevant parameters are set. These parameters may include, without limitation, the name of the user, system ID, location (using GPS or entering manually), time of day, case number, priority, and other custom required data. When the suspect is in sight, the policeman can snap a photo of the individual and activate a voice recording application. The policeman can also set the priority of the photo, for example, without limitation, to high. When finishing recording, the policeman can save the photo, voice recoding and data in the local database of the mobile device and automatically activate synchronization. The publisher database is then updated with the new record, and all of the nodes in the system are updated as soon as they synchronize. Synchronization may start manually by the user or may be setup automatically by a timer to run continuously. The automatic operation may have options such as, but not limited to, running synchronization every time that a change is made to the database, to stop running or slowdown a synchronization attempt upon failure, or on the contrary to stop or slowdown synchronization on success.

Then the mobile devices of other policemen are triggered at the database and activate an application examining the new record just received. If the parameters that were set up in the custom application match, for example, without limitation, location, priority, case number, time, etc., an alarm is raised, the photo is flashed on the screen of the mobile device, the voice message is played, and the corresponding data is available at a click of a button.

Embodiments of the present invention may be used by many types of users. These embodiments are particularly useful for users who are in the field and have the need or desire to record and distribute data in real time. Specific examples of potential users of embodiments of the present invention include, without limitation, law enforcement, security personnel, sales associates, insurance agents, transportation providers, news media, healthcare providers, real-estate agents, education providers, etc.

Some embodiments of the present invention may be used to process photos; however, these embodiments are not limited to processing photos. Those skilled in the art, in light of the present teachings, will recognize that the messages processed by embodiments of the present invention may include various types and combinations of information. For example, without limitation, video clips can be included in the message. In this scenario an originator may open a case with photo, video, voice, and data. A case can be defined as a certain project or a common task that a group of users are working on together. As in the example that will follow of the police perusing a terrorist, this can be a case and many policemen are involved in the case. After the originator opens a case record, other users can then view the record. The application creates a linked record when the users on the network open to view the originator recorded case. The users can now add photo, video, voice, and data to the case. This can be a complete collaboration schema. In a non-limiting example, a detective follows a suspect and snaps a picture of a suspect and maybe a video clip. The detective can then add voice and data to the photo and video and synchronize this to the database. Other detectives then receive the record and may add their own photo, video, voice, and data when they see the suspect and so create a complete set or record. This enables a coordinator at headquarters to receive a complete picture of the movement of the suspect from the detectives in real-time.

An embodiment of the present invention provides distributed processing and messaging capabilities on a network for a mobile distributed processing system (MDPS). In the MDPS every node on the network with computing capabilities is able to send a request or a message to any other node. The requests may be for initializing a process such as, but not limited to, an application or program, and the messages are to be interpreted by the receiving node. The receiving node responds by publishing the progress status and the final result, which in most cases is left on the replication database. The limitation in honoring the request depends on security setup of the particular implementation. In the present embodiment, the schema of the distributed processing and messaging provides for a collaboration of physical units with computing capabilities on a network with a replication database. These capabilities have all the tools for providing collaboration between all the users that are connected to that network.

In the present embodiment, the system is configured with database replication. This means that every node in the system has a replication of the database data, however not all of the data is replicated as some nodes have their data filtered out so that only data needed for that node is not filtered. Every change to data at any node is replicated on all nodes that do not filter.

In a large network with a lot of activity there may be a need for some control and monitoring. In this case one of the computing devices may be designated as an administrator computer and its control table/s are not filtered. The administration computer's tasks include, but are not limited to, monitoring the messaging traffic, correcting errors, sending alerts, processing dead messages, archiving the activity, providing security alerts, and assisting in debugging the system The administrator computer preferably has the capability to change the filtering dynamically, can disable suspect units remotely and is able to send a command to erase or encrypt data. Unlike conventional message queuing approaches the present request control uses database as communication between the computers without an intermediary proprietary server to handle the messages. The approach of the present embodiment works across different devices and operating systems, and is much simpler to use and implement than conventional message queuing and is especially useful for mobile devices.

The use of a replication database schema opens unlimited possibilities of network wide multi-way communication in real time with mobile capabilities. In some embodiments the control can be manual, and alternate embodiments may have automatic control without human intervention. Those skilled in the art, in light of the present teachings, will recognize that various different types of items may be controlled by the network such as, but not limited to, an appliance, machine, light, gate, fire extinguisher, a hothouse environment control, a unit to snap pictures or video, etc. In some embodiments, the database serves as a data repository and also a messaging and application command. The speed and response time of the command request to the time the destination responds with the result can be setup automatically by controlling the frequency of database synchronization in various embodiments. For example, without limitation, a request to destination takes a picture and the time it take for the picture to show up at the requestor may be controlled in some embodiments.

For a mobile unit operated manually, the majority of requests to the mobile unit are for messaging and use in collaboration. In collaboration, the participants are using all kind of methods to share information, and one of those methods may be the exchange of messages. The mobile unit can initiate requests from other more powerful units to process heavy-duty programs and get the results. These capacities of running remote programs that are not practical to run locally make the mobile unit very functional.

For a mobile unit running without manual control, the mobile unit is targeted as a destination receiving a request for running a process and sending the result back. A non-limiting example is a unit that performs surveillance by taking photos, video and voice of the surrounding area. In some embodiments, the unit can also serve as a control of gate, etc. The messaging is limited or not used at all in this mode of operation, also there is very little chance that the unit initiates request to others.

Non-mobile units such as, but not limited to, servers, desktops or laptops are typically connected to the network continuously and are usually are more powerful than the mobile units. Those units use all the capability provided by distributed processing and are limited only by the imagination of the designer.

Mobile units with limited programming capability can send requests to powerful server units that are connected to multiple resources. Once the servers perform a request, the servers can leave the result on the replicated database so that the result can be accessed by the requester unit.

A non-limiting example demonstrates the power of distributed processing, where a small mobile unit can be a powerful tool. A physician with a mobile unit can send a request to a server for receiving updated data on patients that he plans to visit in the hospital. The server gathers data from all of the sources such as, but not limited to, internal databases, external databases of other vendors, the internet, etc. The server then analyzes the patients' data and leaves reports on the replicated database not filtered by the mobile unit. The physician is then able to see on his mobile unit all of the data that is needed about every patient as if he was at a data center. In some implementations, the physician is also able to enter data in hand writing to the mobile unit, which can be printed and added to the chart. By using organization change request (OCR) capabilities the data can be added to the database. This demonstrates the physical collaboration of powerful units with the mobile devices.

In collaboration the data can be of any kind and located in different locations. Sometimes it does not make sense to replicate all of the collaboration data. What is typically replicated is the Mata data, the directory of where all the data may be found, and the security code enabling to access the data. The data can be on a centralized database, the internet, or other sources. The messaging is used for immediate alert and communication. All of the data required for collaboration is typically in a local database provided on a hyperlink with all of the security unlocks to receive the data from the external source.

The messaging process used in the present embodiment is similar to a message queue; however, there is no need to queue the messages as they all are visible on a control table. The message can alert the user to new data, documents, photo, video or events of important. The messaging can also be a tool for collaboration. Furthermore, messaging or process requests may be indexed and used for example, without limitation, to create a dispatch guide indicating the order of execution of requests or to set up a schedule of jobs.

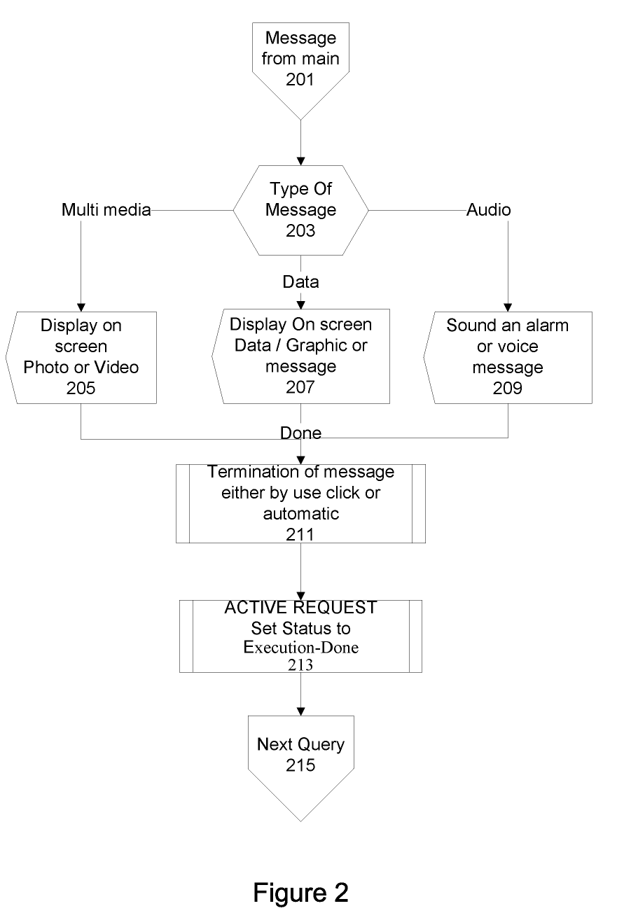

FIG. 2 is a flowchart illustrating exemplary steps in receiving a message in a mobile distributed processing system (MDPS), according to an embodiment of the present invention. The MDPS in the present embodiment uses a replicated database to provide an exchange of data messaging and requests between computing devices such as, but not limited to, computers, laptops and mobile devices. The services of the present embodiment include, without limitation, email, messaging and remote processing. An email service enables the user to send data to a destination device where another user can query a database and process the request to open the email and retrieve the data. A messaging service enables the user to send data as messages to another computing device where a program can process the message automatically. The messaging service may provide various options such as, but not limited to, automatically displaying any type of data on the screen for example, without limitation, photos, videos, or text messages or alerting the user that a message is waiting. Remote processing is a request to process a program on a destination device.

To begin, a message is received by a computing device, typically a mobile device, from a main computing device in step 201. In step 203 the device determines what type of message is being received, multi media, data or audio. If the message is multi media, the message is displayed on a screen of the device for example, without limitation, as a photo or a video in step 205. If the message is data, the data is displayed on the screen of the mobile device for example, without limitation, as a graphic or text in step 207. If the message is audio the device plays the audio, for example, without limitation, sounds an alarm or plays a voice message in step 209. In step 211 the user of the receiving device terminates the message. This may be done manually, for example, without limitation, by pressing a button on the device or automatically by the device. In step 213, the device sends an active request to the main computing device to set the status of the message to execution done. In step 215, the main computing device moves on to the next query.

Some embodiments enable mobile subscribers to store captured photos and or video clips in the database, enter voice recording, add data and system data, enter a selection code of a priority address to a receiver, and enter other vital information. In these embodiments, the database is synchronized and the selected recipient user on the network is able to view the data. Furthermore, the feedback from recipients can take various forms. For example, without limitation, the recipient of the data may just view the data without feedback. The receiving unit may create a linked record to stamp feedback to indicate the receipt of the data or be notified of the status of the data. The recipient of data may add related photos, video, voice, or other data to the case. Or, an application on the supervisor unit of the network may process all of the data from all of the units to create a centralized analysis to provide an overhauled map and report. Another function that may be performed by some embodiments of the present invention enables a user to send an email or message to a recipient while the system monitors if the recipient opened the email or message, and if the recipient does not open the email or message, the system alerts the recipient of the existing email or message and may politely ask the recipient to respond.

A non-limiting example of the use of an MDPS in a real-time situation is as follows. In the present example, a fire department is using an MDPS in collaborating with other entities such as, but not limited to, other fire departments, police, news media, and volunteers to fight a large wildfire. Fire fighters and others in action are provided with a PDA or cell phone for use in the field. These users take picture and/or video of the fire in his/her section with comments, which may include, without limitation, time, location and identity of the user. Other users in the same section are able to see what is happening in the section and add their data and photos. This data is sent to a central computing device at a headquarters. The central computing device may also be able to assemble and analyze all of this data and draw a real-time map of the location and severity of the fire. With this information, the supervisor of the fire fighters receive a clear picture of the location and severity of the fire in all sections and can make immediate decisions on how to proceed. In some embodiments, the supervisor may also add instructions to his fire fighters on how to proceed into a command table. The command may be general to all or may be specific to an individual fire fighter. The data command may be sent in various forms such as, but not limited to, graphic like maps, photos, voice, or video. The supervisor is also able to see which member is communicating by the feedback response. The supervisor may also wish to go out into the field to view the conditions first hand. In this case, the supervisor can bring a mobile device from which he may receive status reports from the central computing device so that he may stay current on the conditions.

Some embodiments of the present invention may include, without limitation, unit automatic control. In these embodiments the same functions that can be performed manually can be programmed to be automatic. For example, without limitation, the unit can take photos and video, record voice, store the data in the database, and initiate synchronization automatically. The application that enables the automatic control processes the table that returns a command to set the timer of trigger operation. Units that may be left out in the field may have a solar panel attached to supply electricity for recharging the mobile unit batteries. In a non-limiting example of an embodiment with unit automatic control, surveillance setup, placing cell phones or PDA usage may be performed in the field of interest. The unit sends continuous data and receives back commands to determine the frequency of synchronization and what data to send.

Some embodiments may also comprise a remote control mobile device (RCMD). In the fire example above, an RCMD may be used to monitor the fire or control fire retardant devices such as, but not limited to, fire extinguisher balloons or a water tank and pump. The RCMD can be housed in a protective box with a solar panel and a battery to provide power to the RCMD at all times. The RCMD may also include an infrared sensor for detecting how close the fire is and send an alert to the central computing device to notify that the fire is nearing the location of the RCMD. This enables an operator to be alerted of the approaching fire so that he can take action, as the operator may be operating many RCMDs at once. The operator may then trigger the fire retardant devices at the ideal time.

Some embodiments of the present invention may include, without limitation, entrance control of a location. Using this function when a request for entrance into a location is made by a person, for example, without limitation, by pushing a button on the door, the unit takes a photo of the person requesting entrance and may also request a form of identification such as, but not limited to, signing onto the unit or a finger print. If the acquired data matches data stored for an authorized person, the person is granted entrance. If not, the data is stored in a database and synchronized to a central unit that may now talk remotely or send authorization through the unit to authorize entrance. This implementation requires minimum need for human intervention.

In applications that do not require high security and are aimed at the public, databases can be published on the internet. In these embodiments a stationary unit such as, but not limited to, a server or desktop, with pix IP that is part of the replication database can serve as a web server displaying the data collected from mobile units.

The protocol for the distributed processing and messaging in the present embodiment is done by using a database control table/s that hold the data exchange of command and respond. Every node is able to access the control table/s and interpret the command or respond depending on if it was the requester or the receiver (destination) of the request, and every node can update the needed data. Other nodes that act as administrators can also modify the data on the control table/s.

The logical description of the control protocol in the preferred embodiment is as follows. The requester node addresses the destination node and makes a request to either initiate a process or sends a message. Then the requester node sets the status to request, and the destination node responds with an acknowledge status. When the destination node starts the process or parses the message, the destination node sets the status to execution in progress. When the process is finished or the message interpretation is done, the destination node sets the status to done and sets the pointer to the result data location as the result can be in another table/s. The command record is then either archived by an administrator server or purged.

Every node in the system according to the present embodiment is assigned with a priority level. Combining the unit level and the command record priority assignment determines what command is honored first. In the preferred embodiment, a supervisor has higher priority (rank has privileges). The algorithm to decide priority is unit priority followed by record priority.

In some embodiments, the replication database has an agreed upon and documented table that serves as messenger and command/response data interface. All units have a special event handler application that interprets the data in this unique table and also inserts data from other application to send messages or command to other units on the enterprise network that are using the same replication database. With this mechanism there is full integration of all units for communication collaboration and remote processing. This is particularly useful for a unit that is not controlled manually.

An exemplary design for a control table in accordance with an embodiment of the present invention is as follows. This is only a simple example and can be extended in alternate embodiments. It is assumed that for this embodiment every unit has a designated known address name. The mobile unit in the field comprises an ID identifier incremental number, a Case ID used for collaboration and mostly messaging, an originator or requester address name, a destination address name, and message or command types. The requester address field, destination address field and message or command type field are significant fields in the control table in the present embodiment. Message or command types may include, without limitation, a process application name to run and initialize a request, or a message to the user such as, but not limited to, Display Photo or video record, Post data on screen, Play voice, Add this file to user computer, a collaboration message, etc. The message may also include a parameters field. If an application requires that parameters have a string, parameters are separated by ‘,’ and parameters text is enclosed in ‘ . . . ’, and numeric without quotation.

The present embodiment comprises a status flag field. In this field various numbers represent that different functions have been performed on the system. For example, without limitation, in the present example, 1 indicates that a message has been sent from the originator, 2 indicates that a message was received by the destination, 3 indicates that a task is being executed by the destination, 4 indicates that the execution has been completed by the destination, and 5 indicates that the record can be purged and put in the archive by the originator. Those skilled in the art, in light of the present teachings, will recognize that various different numbers, letters or symbols may be used to represent various different functions. The present embodiment can also indicate date information such as, but not limited to, a date field message create date, a message received by destination date, a message start execution date, a message end of execution by destination date, a requested date, a start execution by destination date, and a failure date. The destination then positions a pointer to point to result parameters by the executing computer. Optional fields may also be set for the message; for example, without limitation, an Exception Message Priority field may be set with 1 being low priority and 9 being high priority, or a status request field may be set to yes or no. The destination does not need set status after #2. A timeout may also be set to indicate the timeout allowed time before status #2 is set. The system then schedules the date and time that the destination starts executing. For example, without limitation, this may be scheduled as Do not start before: —[CASE ID Requestor address name Destination address name]. The present embodiment comprises an administration computer to monitor the messaging traffic, correct error alerts to dead messages and archive the activity. However, alternate embodiments may be implemented without an administration computer.

The heart of the distributed process of the present embodiment is the control table/s and consideration should be made for security and performance. In the present embodiment, the active table/s size is kept at a minimum. Each of the participating node computers, except the administrator server, is able to access only the record that belongs to the node. The filtering is set so that data is only delivered to a node matching the name address of the unit that is in the Requestor address name field or Destination address name field and the record associated with this address.

The active record that remains on line should only be those that have been created but not yet executed. The administrator server maintains the control table/s. All the records marked as “record can be purged or put in archive (by requestor)” are copied in the administrator server to another table in a database that is not replicated and then the records are deleted from the active replicated database. This way the active control table/s remains slim and has only active records.

Database replication is typically limited to an organization such as, but not limited to, a corporation, social group, school, police force, etc. However, in some instances, users may wish to collaborate with entities outside of the organization, for example, without limitation, vendors, customers, consultants, government authorities, other partners, etc. There may be a desire to share information such as, but not limited to, ideas, documents, files, photos, video, voice, etc. with outsiders. Wider access may be gained by embodiments with a hybrid system using the internet and a gateway web server. In order to gain access to the internal system, which is based on a closed database, the gateway server is part of the replication database with full access, no filter and also functions as a web server that communicates with the outsiders and responds to their requests as if the requests are from a node on the system. The security of the system is checked at the gateway server. The gateway server expends the requests, for example, without limitation, processing, messaging or email, and enables outsiders to gain access to the database in order to retrieve and store data.

Some embodiments of the present invention comprise a destination processor interpreter driver. When a request for process is made, an interpreter program determines what process to start, what data this process needs, continues to run that process until the process is complete, determines if the process has accomplished its task, and determines where the results are or if there was a failure. This interpreter driver sets the status field according to result. One option of waking up the interpreter driver is by a timer that executes the database synchronization program. In an alternate option, a server or even the requester sends a message that there is a new request and the destination device then synchronizes that database to get the command. This second method saves processing because when using a timer there is often no command to handle when the timer interrupts the computer, and in the second method the computer is interrupted only when a command is present. If synchronization is successful, the driver queries the control table to see if there is a new request to its own address. An alternate method of waking up the interpreter driver is by a database trigger of the control table when there is an insert. This usually happens after a successful synchronization, and this method is typically used in non-mobile units. If a request for the local node is discovered, the driver sets the status flag to received status and proceeds to run the required application or process the message. Every application is wrapped in a shell that communicates with the control table to set up the correct status field and the return parameters. The interpreter can be also set up as an independent thread that runs continuously.

A schema for distributed processing and messaging according to an embodiment of the present invention is not limited to a particular operating system or a special database; each computer in the network can have its own specification. Those computers that do not support the common replication database can interface by accessing a remote database on another computer that supports the replication database. As a non-limiting example, some of the mobile units may be able to support MS window mobile and others can support Palm OS or Linux. The database supported can be MS SQLServer, Oracle, MYSQL or others.

Distribution messaging control can lead to some interesting business. A non-limiting example follows. Mobile units are limited in computer power and bandwidth. If a user of a mobile unit needs to run a heavy-duty program such as, but not limited to, stock analysis, a result of a complex report, a search, etc., the mobile unit can send a control command to a server on the network requesting the server to run this program and get the result back. This enables a function of providing computation to mobile devices.

Some will argue that using a portal (web service) can accomplish the same results as an embodiment of an MDPS using a replication database; however there are differences. First, the results for the requests to a web service are not stored in a database that the mobile unit can access. Second, if a connection is broken, the processing stops. Web service is not designed for batch processing, and performance is superior with the replication database approach.

The security of the system in an embodiment using a replication database is superior to internet-based communication. To begin with, Hackers do not have easy access to deal with a replication database. Also, there is a need to install some software on the computers in order for the system to run. Furthermore, there is strong password and filtering protection. All the participants in the system are known, and new or suspect addresses can be detected easily and dealt with. The system is a closed system, which makes the system more secure.

An advantage of using a replication schema according to an embodiment of the present invention is that it is very simple to operate and develop applications and there is built in documentation by assigning logical and understandable names to the field. Furthermore, there is no need for complex message switching protocols that are difficult to understand and install. This schema can be of wider use in initiating remote application and getting the status of the request, meaning whether the request was honored and successful or has failed. Furthermore, security can be built in because the replication schema has built in filtering for the subscriber for example, without limitation, host name or user name and other custom filtering. Only units that are allowed to participate in the collaboration of a certain subject receive the data. The schema is useful for a hieratical organization (priority base) that requires close and secure control. The schema provides for continuous operation even when the connection is sporadic. There is no need for special and proprietary servers as is usually needed for email or message queuing and any other middle server, except the publisher of the database or mail database server, which is generic. The control is peer to peer; however, an administrator server is an option in some embodiments. An email sender receives feedback when the email was read or deleted without reading. Remote devices can be controlled without complex installation and setup and operate without human intervention. Mobile device can ask for services from other more powerful computers and get results. However, there is a need to install Database and operating software on each computer in the system. Also, the system is more closed and not as wide open as the internet; however, there is a possibility of a wider audience using the internet with the same logic in an alternate embodiment.

Database replication is the preferred mechanism for the implementation of distributed processing. Once the database replication is installed, implementation of the distributed processing it is straight forward and as easy as database design without complex communication protocol or complex timing considerations. There is no need for a master control server; however, some embodiments may have an administrator server for monitoring. If the monitoring server is down in an embodiment of the present invention, the system still functions, while with a central control schema according to the prior art when the one database is down, the whole system is down.

Advantages of table control as used in embodiments of the present invention include, but are not limited to, the following. Table control is simple to design, document and understand. It is universal, meaning it can go across different operating systems and configurations. It is versatile and can be used for messaging, running remote applications, and alerting users. Table control includes an automatic trace log and leaves a trail of history. It is easy to debug, and difficult for hackers to crack it. It is ideal for most mobile applications, especially those that are not manual. Disadvantages of table control are that it requires a response time in seconds or even minutes, not milliseconds, and must run an interpreter every time there is database synchronization. Embodiments of the present invention typically require a centralized database or a replication database schema.

Another embodiment of the present invention extends the mobile database network to include an e-mail collaboration process (ECP) that generates real time processes by integrating a database with e-mail. Computer users often find e-mail essential for many of their activities; however, current e-mail systems only deliver messages or file attachments with limited management control and have some security problems. The present embodiment extends e-mail functionality to offer processing capabilities and workflow control. The e-mail system interfaces with database(s) via a program that interoperates the e-mail messages and other messages. This enables e-mail to provide new and advanced services. In the present embodiment, e-mail is the backbone of the business, the super highway and road map for the main business activities. To achieve these goals the e-mail system is an integral part of the enterprise database. In the present embodiment, the collaboration provides e-mail access that is limited and secure. E-mail is part of the enterprise database. The network is structured so that e-mail data can be programmed, and e-mail records and flow behave according to pre determined rules. The network enables the automatic processing of e-mail requests and acts upon results of these requests. The network may also alert the recipient where processes require human intervention, and forward e-mail according to road maps. The data warehouse is driven by e-mail dataflow. Business intelligence is based on historic changes in the data pattern. In the present embodiment the graphic user interface (GUI) has categories and priorities such as, but not limited to, Receiving email may be categorized by impotants of email to the recipient. By way of example and not limitation, a category might be like that for work colleagues wherein a boss and workers in same department would be at a first priority and others at lower priorities. Other category examples include, without limitiation: vendors, customers, friends, others that have correspondent in the past and suspects of spam. The category and priority in the present embodiment are typically setup by the customer administrator.

In the network e-mail messaging to programs may be used instead of a message queue.

In an exemplary architecture for a mobile database network including an ECP, e-mail messages comprise a code and data structure that can be interpreted by an e-mail processing program (EPP). If the EPP finds that there is no code, the e-mail is considered a letter and processed the traditional way. If the EPP finds a code, the EPP parses and analyze the e-mail content and initiates a process according to the code and the input parameters. The EPP interfaces with a system database and is able to query and store data. When sending an e-mail, the EPP creates the message according to the desired process. If a user wishes to send an e-mail, the user can work with a program form that embeds the proper code and data into the email. In the present embodiment, an e-mail address extends to other objects not just a user address such as, but not limited to, a device, a program (subset of a computer or server), a business unit, a social connection group, etc.

Various types of codes may be attached to e-mails in a network according to the present invention. In a traditional e-mail there is no code and no action is taken. A high priority code indicates to the EPP to immediately display the alert message. Alert messages may take various forms for example, without limitation, text, pictures, video, and/or voice. Another type of code may request the system to run a process or program. After the process runs, the result may be stored in the database or the program may send an e-mail with the results to other users or entities. A collaboration e-mail workflow code determines the action of the present node. For example, without limitation, a code to process a program that results in success may prompt the EPP to forward the e-mail to the next node of the workflow, and a code to process a program that results in failure may prompt the EPP to send an e-mail back to the sender with the status. Some codes may require the e-mail recipient handle and process the request manually

In the present embodiment, the EPP interfaces with the e-mail enterprise database. The database data provides the communication protocol and status. The database Mata data provides the rules, the workflow road, users' e-mail addresses, security priority, and other essential information data. There is an interface to the standard e-mail database providing a bridge to the customer database. This enables a customer to use the e-mail operation data with his data warehouse.

The following is an exemplary system configuration for a mobile database network including an ECP in accordance with the present embodiment. The basic parts of the schema include, without limitation, e-mail, the EPP and the enterprise database. Those skilled in the art, in light of the present teachings, will recognize that there are various ways to achieve the functionality of a mobile database network with an ECP using these basic parts. For example, without limitation, e-mail can be delivered in a traditional way through the internet or using the database protocol as in the mobile database network. Also, a message queue is another way of delivering messages. Furthermore, the EPP can be installed on the user computer or can be remotely executed, for example, without limitation, on a network or as a portal through the internet. Also, the database can be installed locally on the user computer and replicated to a publisher server. The database may also be accessed as an enterprise manager (center DB) or accessed through the internet

To illustrate how the collaboration e-mail flow functions, non-limiting examples follow to illustrate the functionalities. In a hypothetical manufacturing company, the company has different functions and dataflow, for example, without limitation, a process from the receipt of a sales order to the final product delivery point and payment. The different departments in the company and the vendors collaborating in the process will be referred to herein as nodes. The process occurring in the present example begins with the receipt of a sales order at a sales order node, then the company performs a credit check on the customer at a credit check node. Then the product ordered is manufactured at a manufacturing node then shipped at a shipping node. The order is then sent to an accounts receivable node and then an account payable node as a sales commission. This workflow assumes no failure. Furthermore, some of these nodes have their own internal dataflow. For example, without limitation, the manufacturing node may have a dataflow beginning with an inventory check node, then an order from a vendor node, then a part delivery node, then manufacturing phases nodes, and finally a quality control node.

In the present example, the EPP processes the protocol and control interfaces directly with the database. Therefore, there is no need for an external interface. Every change or step is recorded directly in the database and is available immediately for reporting and data warehouse cleansing. A new session of workflow process begins when the first node enters the form that initiates the workflow process. In this example the sales order is sent to the credit check node in order to start the session and assign the proper IDs. At the credit check node the code is recognized and the credit check program is automatically started. The result of the credit check program determines if the next node will go forward. In other words, will the workflow continue with the process or will the workflow be returned to the previous node with a failure and discontinue status. In some cases the credit check program may end up in an undetermined state requiring the user recipient of the e-mail to take a manual action, for example, without limitation, verify the customer's employment. The e-mail continues from one node to the next. When the last node is successfully completed, the job is closed and the user who started the job receives a completed e-mail notice. The data in the database is then available for reporting and may be transferred to another user's database.

Another non-limiting example involves a voting ballot. In this example, e-mails with voting forms are sent to all voters. The EPP processes the request when the user votes and clicks to send the information to the database. The user is then flagged as voted so that there will be no multiple voting. The voting result is returned to a central database where the EPP updates the count and the e-mail is stored in archive where there is no human access except under necessary circumstances, for example, without limitation, under a court order in case of a dispute. The system has built in security protection. If a user gets by a security feature, for example, without limitation, by acquiring more than one form to vote, the EPP recognizes that the user has voted already and does not submit the other e-mails to the user for voting. In the case where the central database does not send a voting e-mail to a user, the user can request a voting e-mail and the e-mail is sent automatically if the request is legitimate. This method of voting may be used by organizations such as, but not limited to, unions, corporations, academy awards voting, or any organization that has computer savvy members. The combination of databases and private e-mail makes the system more secure than relying only on a user ID/password combination. The same schema may work for other purposes such as, but not limited to, surveys. In another non-limiting example, a document that needs to be reviewed by peers may be sent as a dataflow where every user can edit the document and the e-mail passes the document to the next user (Node). In a serious debate the document may circulate to the members multiple times. A loan document may also be processed through an e-mail workflow according to an embodiment of the present invention.

In another non-limiting example, an e-mail can be sent to request a remote mobile device to act as a video capture device and control remote devices. In this example, a central operator can command the mobile device to send back photos and the operator can send back a control command to the mobile device to perform a control event. In yet another non-limiting example, e-mail from a mobile device may request processing from a server (resources demanding). At the conclusion of the process the server sends back the e-mail with the results. In yet another non-limiting example immediate message alerts are sent in an emergency situation and the sender receives a status report when the user responds. This application can automatically calculate the number of applicable e-mails sent to notified users. In yet another non-limiting example, e-mails may be sent to taxis that are close to a client location. The first taxi to respond gets the order, and all others receive an order cancelled e-mail. The same logic can be used in other instances, for example, without limitation, bidding in an auction.

A mobile database network including an ECP in accordance with the present embodiment provides a complete communication method between entities such as, but not limited to, users, job centers, computers, mobile devices, programs, or any other entity that uses digital computer devices. The ECP can provide for all the communication needs at a reasonable speed, when working with standard e-mail systems, and can address high-speed needs if using a proprietary high-speed e-mail system. The ECP can work with any software language and operating system such as, but not limited to, UNIX, Windows, Apple etc., or any browser; any protocol that can deliver the e-mail can operate the ECP. The ECP has a multi system configuration; a processing program can reside on a user computer, can be executed from a network server, or can be executed via the internet on a web server. The database can be on the user local computer as a replication database, as an enterprise manger on a network, or may be accessed through an internet web server. In some embodiments, the installation of the ECP on a local computer may not be required, instead the user may use a thin e-mail handler or just logon to a specific web site. In various embodiments, the e-mail ECP system can be private, for example, without limitation, limited to an organization, or public, for example, without limitation, yahoo.com, hotmail.com, etc.

Users can mix and match e-mails with Collaboration Processes (ECP) and other e-mails that have nothing to do with the Collaboration on the same e-mail system without compromising the security or enabling spammers and hackers to penetrate the system. The standardization of sending of sending messages such as, but not limited to, data and processing requests, generally eliminates the need for a proprietary protocol and users do not have to learn new programs. In preferred embodiments there is full control of e-mail activity and users can immediately receive the status of a message. In some embodiments, there is security where users are coded for access and also priorities. The user's information enables the flagging suspicious e-mail. E-mail is encrypted by the interface program so that the interface is seamless to the user. The ECP according to the present embodiment may be safe enough for moving large sums of money anywhere, for example, without limitation, as an electronic transfer.

The present embodiment enables e-mail activities to integrate with database activities and applications. For example, without limitation, the sender of e-mail has an option to receive the full status from the receiver activities. Also, the e-mail receiver has an option to view only data messages or may ask to view the program processed e-mail as well. The user can block any e-mail that he feels is threatening or block the status of this e-mail. There is an immediate status of the activities also available for data warehouse reporting OLAP Online Analytical Processing (OLAP), which is well known approach for analyzing data from various sources as a single identity and reporting it from different angles. The data is typically arranged like a cube and report sliced through the cube of data. The system administrator has full control over all of the e-mail nodes and is able to view any activity. The ECP according to the present embodiment can be used as a controller of hardware devices, for example, without limitation, in the case of house environmental control with or without human need. By using e-mail the communications of the present embodiment are very affordable.

Those skilled in the art, in light of the present teachings will recognize that the ECP concept has the potential of being extended beyond the scope of this document. For example, without limitation, rules and workflow may be modified in real time without causing any slowdown or failure. While e-mails are in a workflow, the processing continues with the existing rules until conclusion. New processes start with the new rules.

Having fully described at least one embodiment of the present invention, other equivalent or alternative means for implementing a mobile database network according to the present invention will be apparent to those skilled in the art. For example, without limitation, the above embodiments describe a photo database; however, alternate embodiments may be used to store and share various other types of files such as, but not limited to, videos, documents, voice recordings, music files, etc. The invention has been described above by way of illustration, and the specific embodiments disclosed are not intended to limit the invention to the particular forms disclosed. The invention is thus to cover all modifications, equivalents, and alternatives falling within the spirit and scope of the following claims.

What is claimed is:

1. A method for mobile distributed processing that uses at least one database as communication means between computers without an intermediary proprietary server to handle the messages, the method comprising the steps of:
receiving, from a server, a message contained in a database;
determining a type of said message for presenting said message;
if said message is of a control type, extracting from said database at least one control table that holds at least data to exchange, a command, and a response, and executing a process corresponding to said command, and when the process is finished or the message interpretation is done, indicating that process is completed a control table, and either archiving or purging said command;
if said message is of a multi media type, at least displaying images contained in said message on a display;
if said message is of a data type, displaying data contained in said message on said display;
if said message is of an audio type, reproducing audio associated with said message in an audible fashion;
terminating receiving of said message; and
sending an active request to said server to set a status of said message in said database to execution done.

2. The method as recited in claim 1, wherein said step of receiving further comprises receiving on a mobile device.

3. The method as recited in claim 2, wherein said step of receiving further comprises receiving over the Internet using a gateway server for security.

4. The method as recited in claim 1, wherein said audio is an alert indicating a further message is available.

5. The method as recited in claim 2, wherein said step of receiving further comprises replicating at least a portion of said database containing said message to form a replicated database.

6. The method as recited in claim 5, wherein said replicating comprises filtering to provide security of information in said database.

7. The method as recited in claim 2, wherein said message comprises, in part, captured information from a user on the system.

8. The method as recited in claim 7, wherein said message further comprises data associated with said captured information.

9. The method as recited in claim 7, wherein said captured information comprises images.

10. The method as recited in claim 2, wherein said step of sending an active request further comprises sending information as to when said message was received.

11. The method as recited in claim 10, wherein said step of sending an active request further comprises sending an additional message to be included in said database with said message.

12. The method as recited in claim 11, wherein said sending an additional message is for the purpose of collaborating with said user.

13. The method as recited in claim 11, wherein said additional message comprises additional captured information.

14. The method as recited in claim 13, wherein said additional captured information comprises images.

15. The method as recited in claim 11, wherein said additional message is added to said replicated database where at least a portion of said replicated database is sent to said server for replicating into said database.

16. The method as recited in claim 2, wherein said step of sending an active request further comprises sending a request to process a program on a destination device and return results in a message form using said database.

17. The method as recited in claim 2, wherein said step of sending an active request further comprises sending a request to control a process on a remote device.

18. The method as recited in claim 2, wherein said step of receiving is on an enterprise network.

19. A method for mobile distributed processing that uses at least one database as communication means between computers without an intermediary proprietary server to handle the messages, the method comprising:
steps for receiving, from a server, a message contained in a database;
steps for determining a type of said message;
steps for processing said message;
steps for terminating receiving of said message; and
steps for sending an active request to said server.

20. A system for mobile distributed processing that uses at least one database as communication means between computers without an intermediary proprietary server to handle the messages, the system comprising:
means for receiving, from a server, a message contained in a database;
means for determining a type of said message for presenting said message;
means for receiving and processing a command and executing a process corresponding to said command;
means for displaying images contained in said message on a display;
means for displaying data contained in said message on said display;
means for reproducing audio associated with said message in an audible fashion;
means for terminating receiving of said message; and
means for sending an active request to said server.
